(19) United States
(12) Patent Application Publication
(10) Pub. No.: US 2016/0280468 A1
(43) Pub. Date: Sep. 29, 2016

(54) CONVEYOR SYSTEM FOR COLD PLANER

(71) Applicant: Caterpillar Paving Products Inc., Brooklyn Park, MN (US)

(72) Inventor: Alan Hsieh, Brooklyn Park, MN (US)

(73) Assignee: Caterpillar Paving Products Inc., Brooklyn Park, MN (US)

(21) Appl. No.: 15/176,747

(22) Filed: Jun. 8, 2016

(51) Int. Cl. B65G 39/12; E01C 23/12; E01C 23/088

(52) U.S. Cl. CPC B65G 39/12; E01C 23/088; E01C 23/127

(57) ABSTRACT

A cold planer has a conveyor system which includes a conveyor frame adapted to receive a conveyor belt. The conveyor frame has a first side plate and a second side plate. The conveyor system includes a roller having a roller body concentrically mounted on a roller shaft. The roller shaft has a first end and a second end. The first end of the roller shaft passes through a hole defined in the first side plate and the second end of the roller shaft passes through a slot defined in the second side plate. A retainer plate removably attached to the second side plate has a groove overlapping with a portion of the slot defined in the second side plate.

### TECHNICAL FIELD

The present disclosure relates to a cold planer. More specifically, the present disclosure relates to a conveyor system of the cold planer.

### BACKGROUND

Asphalt-surfaced roadways are built to facilitate vehicular travel. Depending upon usage density, base conditions, temperature variation, moisture variation, and/or physical age, the surface of the roadways eventually become misshapen, non-planar, unable to support wheel loads, or otherwise unsuitable for vehicular traffic. In order to rehabilitate the roadways for continued vehicular use, spent asphalt is removed in preparation for resurfacing.

Cold planers, sometimes also called road mills or scarifiers, are machines that typically include a frame propelled by tracked drive units. The frame supports an engine, an operator's station, and a milling drum. The milling drum, fitted with cutting tools, is rotated through a suitable interface by the engine to break up the surface of the roadway. Generally, the broken up roadway material is deposited by the milling drum onto a lower or primary conveyor for removal from the underside of the machine. The material is then transferred from the primary conveyor onto an upper or secondary conveyor, which transports the material away from the machine and over a nearby haul truck. The material travels up the secondary conveyor and falls off the end into the haul truck for transportation away from the jobsite. Alternatively, the cold planer may have only one conveyor to transfer the material.

The conveyor may include support rollers and return rollers apart from main rollers to support and rotate a conveyor belt. However, some smaller machines may use only a single type of rollers. The return rollers are mounted on a conveyor frame through a roller shaft. Traditionally, a roller shaft of the return roller is mounted on the conveyor frame by means of additional hardware which is welded to the conveyor frame. Such means for mounting the return rollers add to width of the conveyor frame and the conveyor frame becomes wider than the overall length of the roller shaft. This may cause unnecessary space constraints on the cold planer and may also cause hindrance in sideways movement of the conveyor.

P.C.T. Application No. 2000,078,648 describes a floating axle lock assembly for a general roller conveyor. The axle lock assembly consists of a float plate which receives the axle ends of a rollers in two spaced apart slots. A threaded bolt or stud extends from a position central to the two slots. The stud extends through a centrally located hole in the axle lock, an arcuate metal strip whose respective ends engage one of the axle ends. A hex nut holds the axle lock in place, maintaining the outward force of the ends of the axle lock against the respective axles, urging the axles against the outer edge of the slots. The slots in the float plate are spaced such that the axles are not urged against the edges of the slots in the conveyor frame.

### SUMMARY

In an aspect of the present disclosure, a cold planer having a conveyor system is provided. The conveyor system includes a conveyor frame adapted to receive a conveyor belt. The conveyor frame has a first side plate and a second side plate. The conveyor system includes a roller having a roller body concentrically mounted on a roller shaft. The roller shaft has a first end and a second end. The first end of the roller shaft passes through a hole defined in the first side plate and the second end of the roller shaft passes through a slot defined in the second side plate. A retainer plate is removably attached to the second side plate. The retainer plate has a groove overlapping with a portion of the slot defined in the second side plate.

### BRIEF DESCRIPTION OF DRAWINGS

FIG. 1 shows a cold planer having a conveyor system, in accordance with an embodiment of the present disclosure;

FIG. 2 shows a top view of the conveyor system, in accordance with an embodiment of the present disclosure;

FIG. 3 shows a top view of the conveyor system of FIG. 2 after removing a conveyor belt, in accordance with an embodiment of the present disclosure;

FIG. 4 shows a perspective view of the conveyor system of FIG. 2 from a first end, in accordance with an embodiment of the present disclosure; and

FIG. 5 shows a perspective view of the conveyor system of FIG. 2 from a second end, in accordance with an embodiment of the present disclosure.

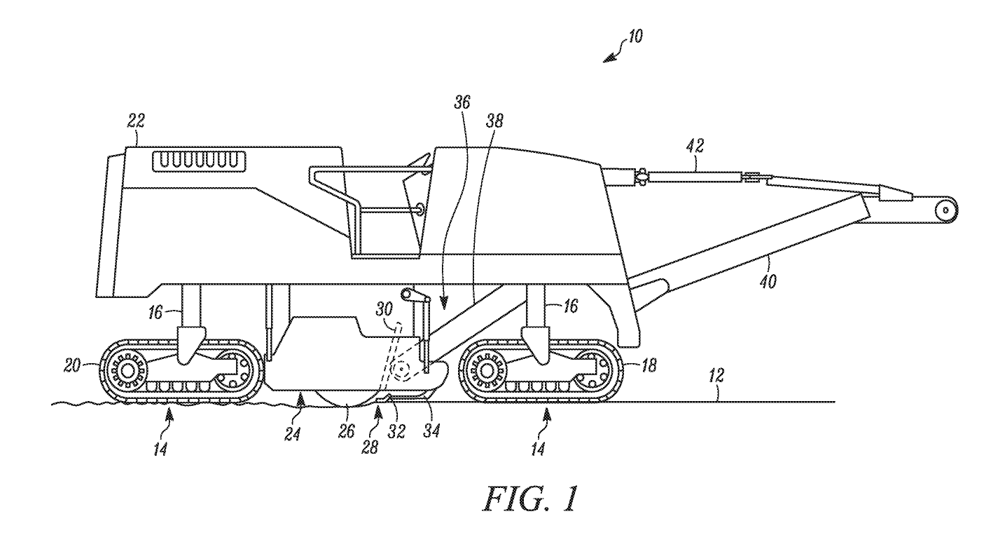

### DETAILED DESCRIPTION

Wherever possible, the same reference numbers will be used throughout the drawings to refer to same or like parts. FIG. 1 illustrates an exemplary machine 10, in accordance with the present disclosure. The machine 10 may be a mobile machine operable to move along aground surface 12 that is underneath the machine 10. The ground surface 12 may be a man-made surface, such as a road, parking lot, concrete cement, or other paved surface. The machine 10 may be configured to perform various functions when traveling over the ground surface 12. In the embodiment shown in FIG. 1, the machine 10 is a cold planer. The machine 10 may cut or grind a top layer of concrete, asphalt, or similar material, to a depth that is typically between 1″ to 14″ below the ground surface 12.

The machine 10 includes a support system 14 to support the machine on the ground surface 12 and a steering system 16 to steer the machine 10 while moving along the ground surface 12. The support system 14 includes one or more front ground-engaging components 18 and one or more rear ground-engaging components 20 for moving along the ground surface 12. FIG. 1 only shows one of the front ground-engaging component 18 on a right side of the machine 10, as well as one of the rear ground-engaging component 20 on the right side of the machine 10. The machine 10 may include similar front and rear ground-engaging components 18, 20 on a left side as well. Each ground-engaging component may include track units, wheels, or skids to move across the ground surface 12.

The machine 10 further includes a frame 22 that serves to tie together and support other components and systems of the machine 10. In addition to the frame 22, the machine 10 may have various other components and systems that serve various purposes. In the embodiment where the machine 10 is a cold planer, the frame 22 supports a material removal mechanism 24 to cut or grind the top layer of the ground surface 12. The material removal mechanism 24 is a grinding mechanism which includes a rotor 26 with a plurality of teeth (not shown) for grinding the ground surface 12. However, the material removal mechanism 24 is not limited to such an arrangement. Although FIG. 1 shows the material removal mechanism 24 housed in a central, lower portion of the machine 10, the material removal mechanism 24 may be disposed in various places on the machine 10. Alternatively or additionally, the machine 10 may include one or more supplementary grinding mechanisms (not shown) located in rear and/or forward positions in the machine 10.

An anti-slabbing mechanism 28 is coupled to the frame 22 and includes an upwardly oriented base plate 30 extending across a front side of the material removal mechanism 24, a forwardly projecting plow 32 for plowing loose material lying upon the ground surface 12, and a plurality of skids 34. Although, the present disclosure includes the anti-slabbing mechanism 28, it should be contemplated that a smaller model of the machine 10 with a rear mounted material removal mechanism 24 may not have the anti-slabbing mechanism 28. In such an embodiment, the machine 10 may provide the milled material through a rear exit to a removable conveyor or directly in the ground surface 12.

A conveyor system 36 is provided to convey the material cut away by the rotor 26 of the material removal mechanism 24 away from the machine 12. The conveyor system 36 includes a primary conveyor 38 (interchangeably referred to as a conveyor 38) positioned forwardly of the base plate 30. The primary conveyor 38 may be coupled to and supported upon the base plate 30, for feeding material cut from the ground surface 12 via the rotor 26 to a secondary conveyor 40 projecting forwardly from the frame 22. A positioning mechanism 42 may be coupled with the secondary conveyor 40, to enable left, right, and potentially up and down position control of the secondary conveyor 40 for conventional purposes. Alternatively, the primary conveyor 38 may transfer material cut from the ground surface 12 directly to a haulage vehicle (not shown) such as a dump truck etc.

The machine 10 may also include one or more power sources (not shown) for powering the material removal mechanism 24, the conveyor system 36, and/or various other components and systems of the machine 10. For example, the machine 10 may include one or more internal combustion engines, batteries, fuel cells, or the like for providing power. The machine 10 may also include various provisions for transmitting power from such power sources to the material removal mechanism 24 and/or various other components of the machine 10. For example, where the machine 10 includes an internal combustion engine as a power source, the machine 10 may include one or more mechanical or electrical power-transmission devices, such as, mechanical transmissions, hydraulic pumps and motors, and/or electric generators and motors, for transmitting power from the engine to the material removal mechanism 24 and the conveyor system 36. The machine 10 may also include a dust suppression system (not shown) which may spray water over the ground surface 12 near the area where rotor 26 cuts the ground surface 12 to suppress dust.

The conveyor system 36 receives material cut away from the ground surface 12 by the material removal mechanism 24 and transfers the material away from the machine 10. The conveyor system includes the primary conveyor 38 and the secondary conveyor 40. In an embodiment, the conveyor system 36 includes the primary conveyor 38 only. The primary and secondary conveyors 36, 38 may have similar or different designs.

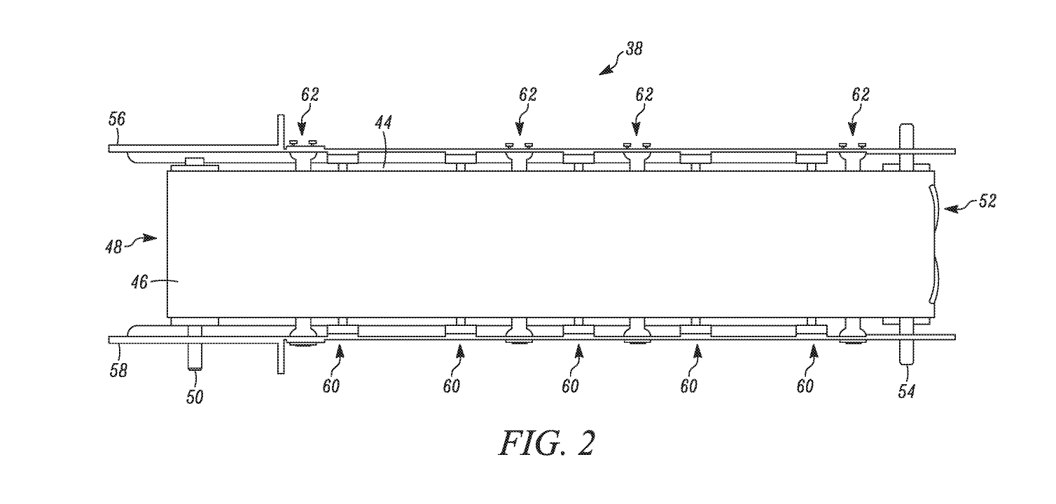

FIGS. 2-5 illustrate various aspects of a design of the conveyor 38. FIG. 2 shows a top view of the conveyor 38 having a conveyor frame 44 which receives a conveyor belt 46 around the conveyor frame 44 to carry the material cut away from the ground surface 12. The conveyor belt 46 may be made up of any suitable material in accordance with the present disclosure. The conveyor frame 44 has a first end 48 having a first pulley 50 and a second end 52 having a second pulley 54 to rotate the conveyor belt 46 around the conveyor frame 44. The first and the second pulleys 50, 54 may be powered by the power source in order to rotate the conveyor belt 46 around the conveyor frame 44.

The conveyor frame 44 further includes a first side plate 56 and a second side plate 58 to prevent material spilling sideways from the conveyor belt 46. The first and second side plates 56, 58 may be attached to the conveyor frame by any mechanical joining means such as welding, brazing, mechanical fasteners etc. The first and second side plates 56, 58 may also include sealing means (not shown) between the conveyor belt 46 and the first and second side plates 56, 58 to avoid any spillage of the material. The conveyor frame 44 further includes multiple rollers to support the rotation of the conveyor belt 46 around the conveyor frame 44. A set of support rollers 60 supports the conveyor belt 46 passing above the conveyor frame 44 from the first end 48 towards the second end 52. The support rollers 60 may or may not be powered and may be provided only for supporting the conveyor belt 46. A set of return rollers 62 helps in returning the conveyor belt 46 from below the conveyor frame 44 once the conveyor belt 46 passes the second end 52 and returns towards the first end 48.

The support rollers 60 and the return rollers 62 may derive required operating power from the power source. Alternatively or additionally, the support rollers 60 and the return rollers 62 may have separate means to derive required operating power. The support rollers 60 and the return rollers 62 may have similar or different constructional features. Also, similar or different methods may be used to mount the support rollers 60 and the return rollers 62 on the conveyor frame 44. A mounting arrangement will be explained further with reference to the return roller 62. It should be contemplated that the support rollers 60 may or may not have a similar mounting arrangement.

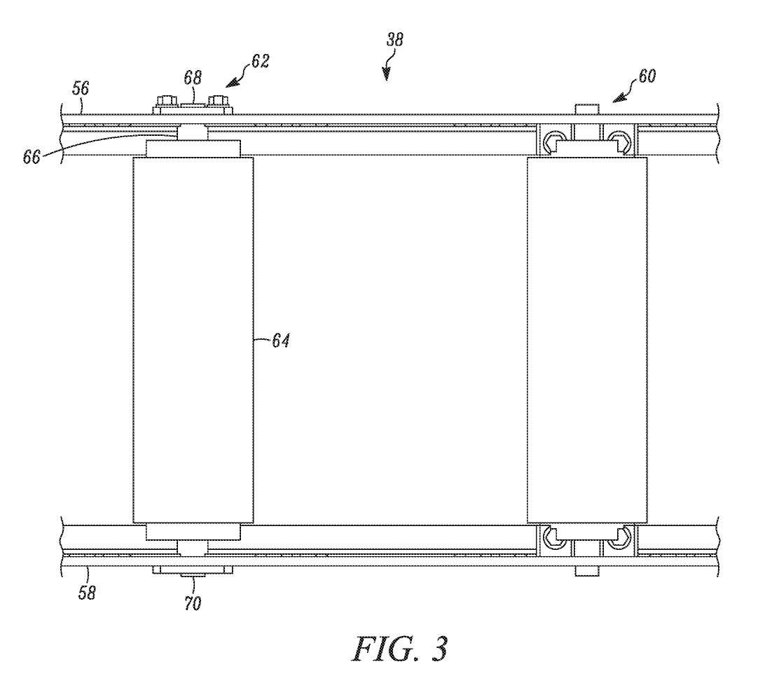

FIG. 3 illustrates the conveyor 38 without the conveyor belt 46. The support roller 60 and the return roller 62 are located between the first and the second side plates 56, 58. The return roller 62 has a roller body 64 concentrically attached to a roller shaft 66. The roller body 64 and the roller shaft 66 may be an integral part. Alternatively, the roller body 64 may rotate relative to the roller shaft 66. The roller shaft 66 has a first end 68 mounted on the first side plate 56 and a second end 70 mounted on the second side plate 58.

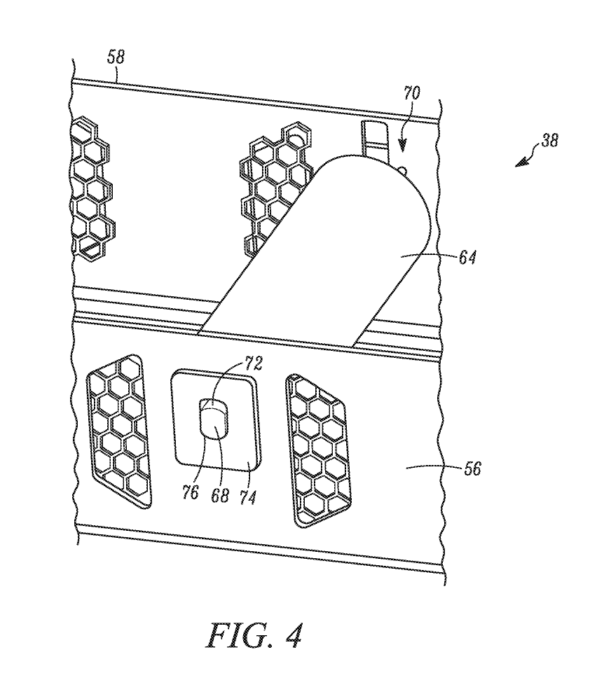

As illustrated in FIG. 4, the first side plate 56 has a hole 72 defined in the first side plate 56. The hole 72 would be defined in the first side plate 56 such as to allow the first end 68 of the roller shaft 66 to pass through the hole 72. The roller shaft 66 may be a cylindrical part having a circular cross section. The roller shaft 66 may have any other cross-sectional shape as well. In the illustrated embodiment, the roller shaft 66 has a cross-sectional shape of a circular cross-section compressed to provide two flat sides. It may also be possible that the roller shaft 66 may have different cross-sectional shape at the first end 68 compared to a middle portion of the roller shaft 66. The hole 72 may be circular, cylindrical or any other shape corresponding to the cross-sectional shape of the roller shaft 66. The dimensions of the hole 72 would be such as to just allow the roller shaft 66 to pass through the hole 72. A back-up plate 74 having an opening is attached to the first side plate 56.

The back-up plate 74 may provide additional structural rigidity to the first side plate 56 around the hole 72 as there may be increased stress concentrations. The back-up plate 74 may be attached to the first side plate 56 by any mechanical joining means such as welding, brazing, adhesive means, mechanical fasteners etc. The back-up plate 74 may be attached to the first side plate 56 by any means suitable to the application of the present disclosure. The first end 68 of the roller shaft 66 passing through the hole 72 in the first side plate 56 further passes through an opening 76 in the back-up plate 74. Shape of the opening 76 may preferably be dimensionally similar to or slightly bigger than the hole 72 so as to allow the first end 68 of the roller shaft 66 to pass through the opening 76. Although the present disclosure is described as including the back-up plate 74 attached to the first side plate 56, in an embodiment, the back-up plate 74 may not be required based on thickness of the first side plate 56. Calculations may be done to determine a required thickness for supporting the first end 68 of the roller shaft 66, and the hack-up plate 74 may not be required if the first side plate 56 provides the required thickness. The second end 70 of the roller shaft 66 is mounted on the second side plate 58.

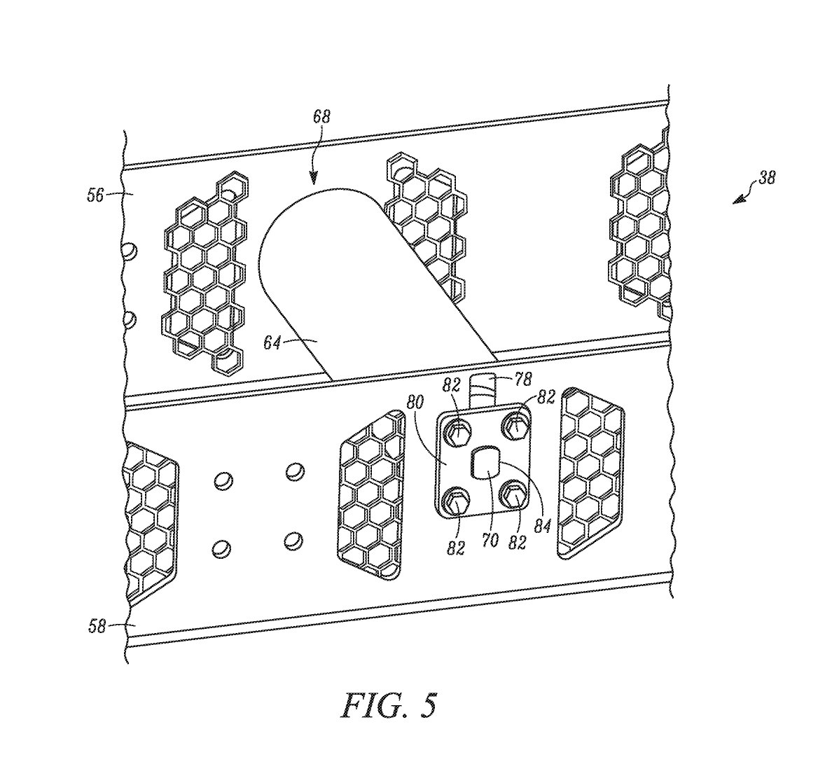

As shown in FIG. 5, the second side plate 58 has a slot 78 defined in the second side plate 58. The slot 78 is defined in the second side plate 58 so as to allow the second end 70 of the roller shaft 66 to pass through the slot 78. The second end 70 of the roller shaft 66 may have a similar cross-section to the first end 68. In the illustrated embodiment, the second end 70 of the roller shaft 66 has cross-sectional shape identical to the first end 68. However, in an embodiment, the first and second ends 68, 70 of the roller shaft 66 may have different cross-sectional shape. The slot 78 has a width dimension corresponding to the cross-sectional shape of the roller shaft 66. A length dimension of the slot 78 extends in upwards direction on the second side plate 58. The slot 78 has an extended length dimension as opposed to the hole 72 to allow mounting/removal of the roller shaft 66 from between the first and second side plates 56, 58. In an embodiment, the slot 78 may also be a labyrinth style slot. The slot 78 may extend upwards slightly and have a further lateral extension to allow removal of the roller shaft 66 at the second end 70. Any other configuration of the slot 78 may also be possible which may be suitable to the present disclosure. A retainer plate 80 is provided to fix the position of the second end 70 of the roller shaft 66 in the slot 78.

As illustrated, the retainer plate 80 is attached to the second side plate 58 by means of multiple bolts 82. Any other mechanical fastening means may also be used which may suit the need of the present application such as clamps etc. Using mechanical fastening means instead of permanent fastening means such as welding etc. allows easy assembly/removal of the retainer plate 80 and subsequently the roller shaft 66. The retainer plate 80 includes a groove 84 corresponding to the cross-sectional shape of the roller shaft 66 so as to allow the second end 70 of the roller shaft 66 to pass through the retainer plate 80. Shape of the groove 84 is so as to allow the second end 70 of the roller shaft 66 to pass through. The shape of the groove 84 may be dimensionally similar to the hole 72 in the width dimension and may be equal to or slightly greater than the cross-sectional area of the second end 70 of the roller shaft 66.

### INDUSTRIAL APPLICABILITY

Conveyors are often used to move material in a variety of settings. One example setting, but by no means, is a limiting example, is the use of a conveyor to move asphalt or other roadbed material from a cold planer machine to another vehicle. The second vehicle is often used to haul away the material moved by the conveyor. Due to the variety of settings and equipment that may be used in a milling operation, it may be desirable to provide a wide range of locations for the output of the material carried by the conveyor. One way to provide a multiple of locations for the output of the material is to provide a system of multiple conveyors. When multiple conveyors are used, they may be able to move by pivoting with respect to each other in order to adjust the final output of material. For example, by pivoting left or right with respect to a first conveyor, the output of the material may be moved to the left or to the right. By allowing the second conveyor to also pivot with respect to an elevation axis, the output of material can be raised or lowered as desired. However, as the conveyors include multiple rollers to support and rotate a conveyor belt around a conveyor frame, current mounting arrangements of the rollers are such that the conveyor frame is wider than a length of a roller shaft which causes constraints in sideways movement of the conveyor.

The present disclosure provides a solution to the problems by offering an improved mounting arrangement of the return rollers 62. The conveyor 38 includes the conveyor frame 44 having the first and second side plates 56, 58. The return rollers 62 are located between the first and second side plates 56, 58. The return roller 62 includes the roller body 64 concentrically mounted on the roller shaft 66. The first end 68 of the roller shaft 66 is attached to the first side plate 56 and the second end 70 of the roller shaft 66 is attached to the second side plate 58. The first end 68 of the roller shaft 66 passes through the hole 72 defined in the first side plate 56 and the opening 76 in the back-up plate 74 attached to the first side plate 56. Similarly, the second end 70 of the roller shaft 66 passes through the slot 78 defined in the second side plate 58 and the groove 84 in the retainer plate 80 attached to the second side plate 58. The retainer plate 80 is held in place by mechanical fastening means such as bolts 82.

The mounting arrangement explained above provides with a relatively reduced width dimension of the conveyor frame 44 as the return rollers 62 are mounted in the hole 72 and slot 78 defined in the first and second side plates 56, 58 respectively. No additional hardware is required to be mounted, causing the effective width dimension of the conveyor frame 44 to be lesser than the length of the roller shaft 66. The reduced width allows the conveyor 38 relatively greater ranges of angular spatial movement as compared to prior art designs. Also, the reduced width saves space on the machine 10 so that any additional components may be mounted. Further, no requirement of additional hardware for mounting also contributes towards reduction in weight carried by the machine 10 as well. The conveyor 38 may move more efficiently and access more sideways space in a better and efficient manner.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cold planer having a conveyor system, the conveyor system comprising:
a conveyor frame adapted to receive a conveyor belt, the conveyor frame including a first side plate and a second side plate;
a roller having a roller body concentrically mounted on a roller shaft, the roller shaft having a first end and a second end, wherein the first end of the roller shaft passes through a hole defined in the first side plate and the second end of the roller shaft passes through a slot defined in the second side plate; and
a retainer plate removably attached to the second side plate, the retainer plate having a groove overlapping with a portion of the slot defined in the second side plate.

2. The cold planar of claim 1, wherein the conveyor system further includes a back-up plate attached to the first side plate, the back-up plate having an opening corresponding to the hole defined in the first side plate.
